(19) United States
(12) Patent Application Publication
(10) Pub. No.: US 2005/0160448 A1
(43) Pub. Date: Jul. 21, 2005

(54) Smartcard uart for minimizing processor demands in a conditional access system

(76) Inventors: David Jay Duffield, Indianapolis, IN (US); Jeffrey Allen Cooper, Rockey Hill, NJ (US); Mohan Narasimhan, San Jose, CA (US)

Correspondence Address: Joseph S Tripoli;Thomson Licensing Inc, PO Box 5312, Princeton, NJ, 08543-5312, US

(21) Appl. No.: 10/490,679

(22) PCT Filed: Sep. 28, 2001
(86) PCT No.: PCT/US01/30544

(51) Int. Cl. H04N 7/16

(52) U.S. Cl. 725/2

(57) ABSTRACT

A smart card UART which includes a memory capable of storing a 5 byte command string along with error data. Inclusion of a memory in the UART allows the smart card to store serial communications commands received from a serial interface until the smart card processor is able to process such commands.

### FIELD OF THE INVENTION

This present invention concerns a Universal Asynchronous Receive/Transmit (UART) circuit. The UART circuit may be implemented in a smart card of a conditional access system for providing conditional access to a received scrambled audio/visual (A/V) signal from a variety of sources, such as broadcast television networks, cable television networks, digital satellite systems, and internet service providers.

### BACKGROUND OF THE INVENTION

Today, a user may receive services from a variety of service providers, such as broadcast television networks, cable television networks, digital satellite systems, and internet service providers. Most television receivers are capable of receiving unscrambled information or programs directly from broadcast and cable networks. Cable networks providing scrambled programs usually require a set-top box (STB) or similar device to descramble the program. Similarly, digital satellite systems usually provide scrambled programs that also require the use of a set-top box. These set-top boxes may utilize removable smart cards which contain the data necessary for recovering the descrambling keys to descramble the respective programs.

Conditional access (CA) systems are typically comprised of a network of service providers and subscribers, as well as a conditional access authority. The service providers transmit signals to the subscribers, and the conditional access authority controls which signals each of the subscribers are permitted to receive. The subscribers' access to these signals depends upon the particular program packages to which they have subscribed (e.g., basic cable, basic cable and Home Box Office (HBO), etc.). As referred to above, the conditional access to the signals of the different service providers may be handled through a smart card which is disposed in a set-top box (STB), digital television (DTV), digital videocassette recorder (DVCR) or other equivalent device. Currently, most conditional access system utilize STBs, but in the future the extension to include smart cards in DTVs and DVCRs is anticipated. These smart cards usually contain descrambling keys which are used to descramble the different signals of the service providers.

Among other circuitry, some smart cards contain Universal Asynchronous Receive/Transmit (UART) circuits for coordinating communications from other circuits to the smart card, and from the smart card to other circuits. In general, UARTs are designed to be general purpose, and programmable to support multiple communication protocols. ISO-7816 is a conventional protocol for smart card communications, and many smart card UARTs are programmable to receive data (e.g., serial communication commands) in the ISO-7816 format. However, conventional smart cards (and thus UARTs) operating under the ISO-7816 protocol do not operate effectively when the smart card processor (which is typically internal to the smart card) is subject to interrupts, and lengthy routines that cannot be interrupted by incoming serial port messages. For example, if the smart card processor is running an uninterruptable decryption program when a serial communication command (e.g., ISO-7816 command) is received from an interface device (e.g., STB), the smart card processor may not be able to respond to the serial communication command, and therefore data from the serial port of the interface device will be lost.

The EIA-679 standard (NRSS) outlines an extension to the ISO-7816 smart card that has a high speed data connection, as well as a serial communications port available in other ISO-7816 designs. The high speed data connection requires processing as well, and is typically connected to the smart card processor through some sort of interrupt circuit. In NRSS designs under the EIA-679 standard, there are two separate input paths that will place demands on the smart card processor (e.g., the high speed data path and the serial path). Thus, prioritization and interrupts are far more likely to be necessary. This creates the potential problem that the smart card processor may be busy processing input from the high speed connection when a serial 7816 command is sent by an interface device (e.g., STB).

Within the ISO-7816 specification, two devices participate in the system, an “interface device” and a “card.” The “interface device” is the host device (e.g., STB) that supplies power, a smart card reader, and is generally the master in communications. The “card” is simply the smart card. ISO-7816 also defines several communications protocols. One of the most commonly used is known as “T=0.” ISO-7816 T=0 commands begin with a five (5) byte command string sent from the interface device (e.g., STB) to the smart card, indicating (1) class, (2) instruction (INS) command, (3) P1, (4) P2, (5) N. The “class” byte defines the instruction class, and the “instruction (INS) command” byte specifies what data is to follow, and whether the data (bytes) to follow the 5 byte string are sent or received by the interface device (e.g., STB). P1 and P2 define instruction specific parameters (e.g., an address), and N defines the number of bytes to follow the 5 byte string.

If the “instruction (INS) command” byte specifies a “READ” command, data is transmitted from the smart card to the interface device (e.g., STB), however, if the “instruction (INS) command” byte specifies a “WRITE” command, data is transmitted from the interface device to the smart card. When data is transmitted from the smart card to the interface device (i.e., during a READ operation), the smart card may wait as long as necessary (within a ‘working interval’ of several hundred milliseconds) to send the data, and has control over this timing. Thus, the smart card (actually the smart card processor) can be interrupted, or take time to complete other tasks. When a WRITE command is executed, the smart card responds by sending an acknowledgment message within a ‘working interval.’ The acknowledgment message specifies how many bytes can be sent to the smart card.

However, because under current standards (e.g., ISO-7816, EIA-679) a smart card processor may be busy executing programs which cannot be interrupted when a serial communication command is received from the interface device (e.g., STB), serial communication data can often be lost.

Thus, there is presently a need for a smart card with a UART which can handle incoming serial communication commands from an interface device without loss of data, or interrupting the smart card processor.

### SUMMARY OF THE INVENTION

The present invention is a method and apparatus for managing access to a signal, the method comprising receiving in a smart card a command string, the command string including at least five bytes of data, and, storing said at least five bytes of data in a memory area of a Universal Asynchronous Receive/Transmit UART) circuit.

### BRIEF DESCRIPTION OF THE DRAWINGS

FIG. 1 is a register map showing memory locations and content of a UART according to an exemplary embodiment of the present invention.

FIG. 2 is a block diagram illustrating one architecture for interfacing a digital television (DTV), including a smart card and the UART according to the exemplary embodiment of the present invention, to a variety of service providers.

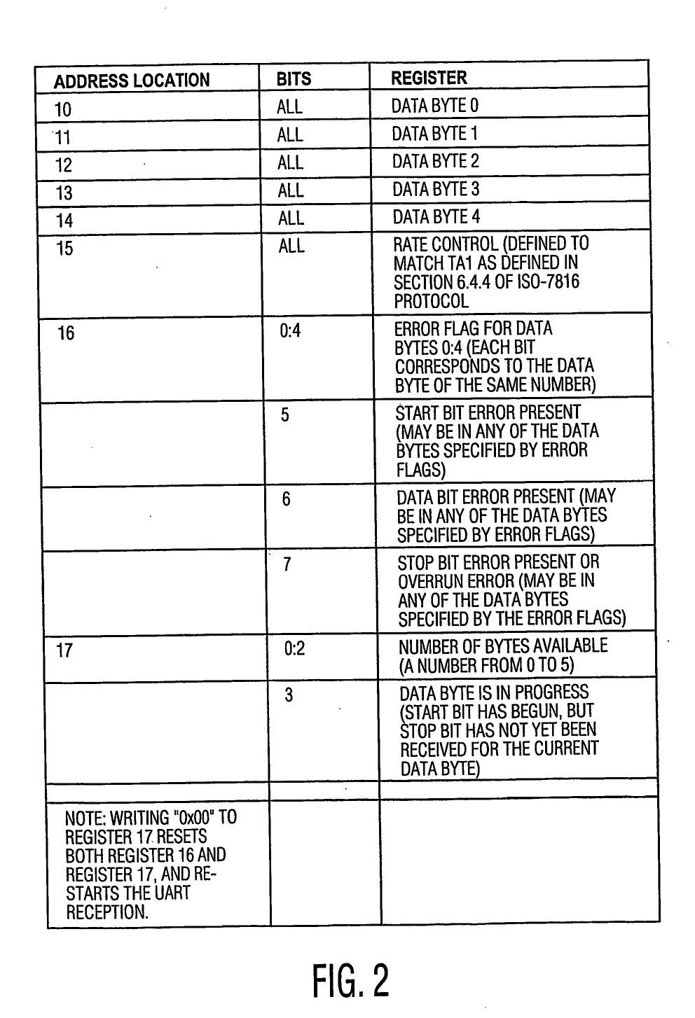

### DETAILED DESCRIPTION

The present invention comprises a Universal Asynchronous Receive/Transmit (UART) circuit, preferably for implementation in a smart card, with a memory capable of storing at least five (5) bytes of command data, as well as error data. The 5-byte memory is preferably implemented as a separate piece of hardware (e.g., memory cell) within the UART circuit. The UART circuit according to the exemplary embodiment of the present invention preferably performs serial to parallel conversion and storage of data into the memory without the use of software (i.e., the 5-byte memory is a hardware memory). Such a UART allows the initial ISO-7816 5-byte command string to be stored in the event that the smart card processor (which is typically internal to the smart card) is engaged performing other tasks. Then, when the smart card processor has completed the ‘other tasks’, the command string can be recovered and processed immediately.

If the command string specifies a READ command, data will be sent to the interface device from the smart card. If the command string specifies a WRITE command, the smart card processor can decide whether to allow all the relevant data to be sent to the smart card at once, or just a single byte at a time. The smart card processor can specify in an acknowledgement message to the interface device (e.g., STB) exactly how many bytes will be sent at a time. If, during a WRITE command, the smart card processor decides to allow all relevant data to be sent at one time, the smart card processor must insure that all interruptions are less than the time required to transfer 5 bytes (since 5 bytes is the maximum allowable header message under the ISO-7816 standard, and since 5 bytes is the maximum amount of data that the UART according to the present invention can hold). If the smart card processor cannot insure this, the smart card processor can allow only one byte at a time to be sent to the interface device (which is slower, but allows for extended interrupts).

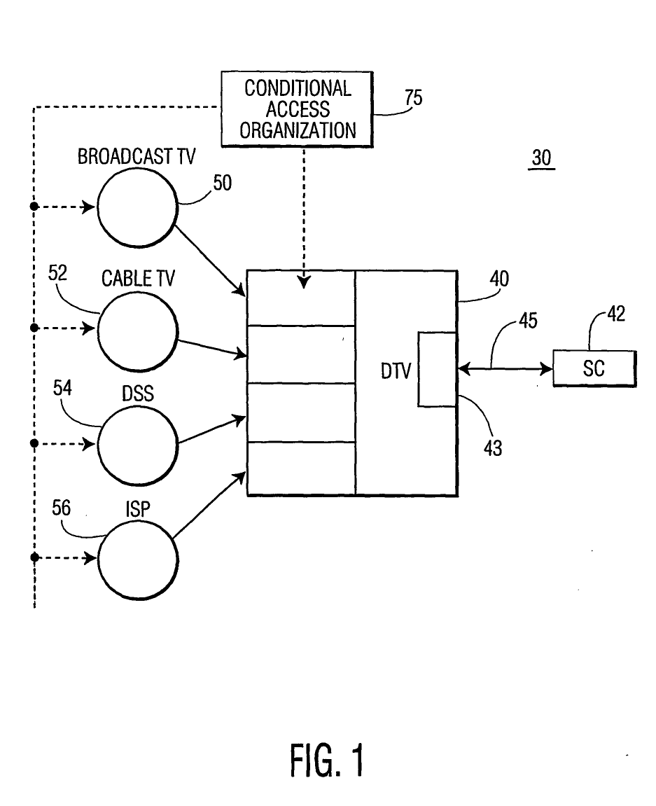

FIG. 1 shows a sample memory register map for the UART according to the exemplary embodiment of the present invention. As will be understood, the first 5 address locations (10-14) are used for storing the 5 bytes of the 5 byte command string. In particular, location 10 may store the “class” byte, location 11, may store the “instruction (INS) command” byte, locations 12 may store the “P1” byte, location 13 may store the “P2” byte, and location 14 may store the “N” byte. Locations 15-17 are used primarily for storing error information, as explained below. Location 15 may store a parameter to define the bit rate used for serial communications. Location 16 may store 5 error flags (one for each byte of data the UART can hold) that indicate which data bytes may have errors. Location 16 may also contain three flags to indicate what type of error has been detected. Location 17 may store a count of how many bytes the UART has captured, and a flag to warn that a byte is currently being captured. Of course it will be understood that the particular configuration of bytes and memory locations discussed above is only exemplary, and any byte may be stored in any of the address locations.

The UART circuit according to the exemplary embodiment of the present invention is preferably implemented in a smart card of a conditional access (CA) system which may be utilized to obtain programs and services from one of a plurality of sources. The conditional access system when implemented within a device, such as a digital television (DTV), digital video cassette recorder (DVCR) or set-top box (STB), provides convenient management of the descrambling keys. For simplicity, the below description of the invention will be directed towards an implementation using a digital television (DTV) and a smart card including the present UART circuit.

FIG. 1 depicts a system 30 for managing access to a digital television (DTV) 40. A smart card (SC) 42 is inserted into, or coupled to, a smart card reader 43 of the DTV 40, and an internal bus 45 interconnects DTV 40 and SC 42 thereby permitting the transfer of data therebetween. The UART according to the exemplary embodiment of the present invention is preferably formed as an integral part of smart card 42, however, the UART may be formed as a separate element.

DTV 40 can receive services from a plurality of service providers (SPs), such as a broadcast television SP 50, a cable television SP 52, a satellite system SP 54, and an internet SP 56. Conditional Access Organization (CA) 75 is not directly connected to either the service providers 50-56 or DTV 40 but deals with key management and issues key pairs which may be used to limit access to the programs transmitted by the service providers 50-56.

As is well known in the art, smart card 42 of the system 30 preferably includes input/output terminals, a processor, a memory, and a UART circuit. In the exemplary embodiment of the present invention the UART circuit comprises a UART circuit as described above including a memory for storing a 5 byte command string and error data.

Although the UART according to the exemplary embodiment of the present invention is preferably used in a smart card of a conditional access system, it will be understood by those skilled in the art that the present smart card UART may be implemented in a variety of systems (e.g., credit card systems, automated teller machine (ATM) systems, building security systems, personal computer e-commerce or access control systems, parking garage systems, public and private telephone systems, postage systems, public key infrastructure (PKI) key management systems, video game systems, etc.) without departing from the scope of the present invention.

1. A method for managing access to a signal, said method comprising:
receiving in a smart card a command string including at least five bytes of data; and,
storing said at least five bytes of data in a memory area of a Universal Asynchronous Receive/Transmit (UART) circuit.

2. The method of claim 1 comprising the further step of:
retrieving said at least five bytes of data stored in the memory area of the UART circuit.

3. The method of claim 1 comprising the further steps of:
permitting data to be received by the smart card if the at least five bytes of data specify a write operation; and,
permitting data to be sent by the smart card if the at least five bytes of data specify a read operation.

4. The method of claim 1, comprising the further step of:
storing error information in a memory area of a Universal Asynchronous Receive/Transmit (UART) circuit.

5. The method of claim 5, wherein the error information pertains to the at least five bytes of data.

6. The method of claim 1, wherein the Universal Asynchronous Receive/Transmit (UART) circuit is contained within the smart card.

7. The method of claim 1, wherein the step of storing said at least five bytes of data comprises:
storing at least one byte of data specifying an instruction class;
storing at least one byte of data specifying an instruction command;
storing at least one byte of data specifying a first address;
storing at least one byte of data specifying a second address; and,
storing at least one byte of data specifying a number of bytes of data.

8. The method of claim 1, wherein the memory area is implemented as a separate piece of hardware within the UART circuit.

9. The method of claim 1, wherein the UART circuit performs serial to parallel conversion and storage of data into the memory area without the use of software.

10. A system for managing access between a service provider and a device having a smart card coupled thereto, said device performing the steps of:
receiving in a smart card a command string, said command string including at least five bytes of data; and,
storing said at least five bytes of data in a memory area of a Universal Asynchronous Receive/Transmit (UART) circuit.

11. The system of claim 10, wherein the Universal Asynchronous Receive/Transmit (UART) circuit is contained within the smart card.

12. A Universal Asynchronous Receive/Transmit (UART) circuit comprising:
a first memory area for storing at least five bytes of information corresponding to a command string.

13. The UART of claim 12, further comprising:
a second memory area for storing error information.

14. The UART of claim 12, wherein the at least five bytes of information includes:
at least one first byte of data specifying an instruction class;
at least one second byte of data specifying an instruction command;
at least one byte of data specifying a first address;
at least one byte of data specifying a second address; and,
at least one byte of data specifying number of bytes of data.

15. The UART of claim 13, wherein the error information includes:
at least five error flags, said at least five error flag corresponding to said at least five bytes of information respectively.

16. The UART of claim 13, further comprising:
a third memory area for storing a bit rate parameter.

17. The UART of claim 16, further comprising:
a fourth memory area for storing a number indicative of how many bytes the UART has received, and a flag indicative of whether a byte of data is currently being received.

18. The UART of claim 12, wherein the UART performs serial to parallel conversion and storage of data into the first memory area without the use of software.

19. A smart card comprising:
a processor; and,
a Universal Asynchronous Receive/Transmit (UART) circuit including a first memory area for storing at least five bytes of information corresponding to a command string.

20. The smart card of claim 19, wherein the UART further comprises: a second memory area for storing error information.

21. The smart card of claim 19, wherein the at least five bytes of information includes:
at least one first byte of data specifying an instruction class;
at least one second byte of data specifying an instruction command;
at least one byte of data specifying a first address;
at least one byte of data specifying a second address; and,
at least one byte of data specifying number of bytes of data.

22. A method for operating a smart card, said method comprising:
receiving in a smart card a command string including at least five bytes of data; and,
storing said at least five bytes of data in a memory area of a Universal Asynchronous Receive/Transmit (UART) circuit.
